(19) United States
(12) Patent Application Publication
(10) Pub. No.: US 2026/0341897 A1
(43) Pub. Date: Oct. 29, 2026

(54) BATTERY MODULE

(71) Applicant: SAMSUNG SDI CO., LTD., Yongin-si (KR)

(72) Inventor: SEUNGHAN YOON, Yongin-si (KR)

(21) Appl. No.: 19/410,205

(22) Filed: Dec. 5, 2025

(30) Foreign Application Priority Data
Apr. 23, 2025 (KR) 10-2025-0053116

(51) Int. Cl. H01M 50/367; H01M 50/271; H01M 50/383; H01M 50/627; H01M 50/209

(52) U.S. Cl. CPC H01M 50/367; H01M 50/271; H01M 50/383; H01M 50/627; H01M 50/209

(57) ABSTRACT

A battery module, including a plurality of battery cells, each including a vent, resulting in vents, the plurality of battery cells being in parallel along a first direction, an upper cover covering the plurality of battery cells, and a flow path positioned between the plurality of battery cells and the upper cover, a fire extinguishing fluid flowing in the flow path, wherein the flow path includes a plurality of openings respectively corresponding to the vents of a plurality of battery cells and a first cover portion covering each of the plurality of openings, resulting in first cover portions.

### CROSS-REFERENCE TO RELATED APPLICATION

This application is based on and claims priority under 35 U.S.C. §119 to Korean Patent Application No. 10-2025-0053116, filed on Apr. 23, 2024, in the Korean Intellectual Property Office, the disclosure of which is incorporated by reference herein in its entirety.

### BACKGROUND

### 1. Field

The disclosure relates to a battery module.

### 2. Description of the Related Art

Secondary batteries are batteries that can be charged and discharged, unlike primary batteries that cannot be recharged. Low-capacity secondary batteries are used in small, portable electronic devices such as smartphones, feature phones, laptops, digital cameras, and camcorders, while high-capacity secondary batteries are widely used as power sources for driving motors in hybrid cars, electric cars, or the like and as power storage batteries. Such a secondary battery includes an electrode assembly including a positive electrode and a negative electrode, a case for accommodating the electrode assembly, and electrode terminals connected to the electrode assembly.

The above-described information disclosed in the background technology of the disclosure is only intended to improve understanding of the background of the disclosure and therefore may include information that does not constitute prior art.

### SUMMARY

Embodiments include a battery module, including a plurality of battery cells including a plurality of vents, respectively, the plurality of battery cells being in parallel to each other along a first direction, an upper cover covering the plurality of battery cells, and a flow path positioned between the plurality of battery cells and the upper cover, a fire extinguishing fluid flowing in the flow path, wherein the flow path includes a plurality of openings respectively corresponding to the plurality of vents of the plurality of battery cells and a first cover portion covering each of the plurality of openings to define a first cover portion.

The plurality of openings may include openings in an upper portion of the flow path and a lower portion of the flow path at positions corresponding the plurality of vents, respectively.

The first cover portion may enclose the flow path to cover each of the plurality of openings.

The first cover portion may further include a plug portion in each of the plurality of openings.

A melting point of the flow path may be higher than a melting point of the first cover portion.

At least three of the plurality of openings may be along an outer circumferential surface of the flow path in a cross section of the flow path which is perpendicular to a longitudinal direction of the flow path.

The upper cover may include open portions respectively corresponding to the first cover portion of each of the plurality of openings.

The upper cover may further includes a second cover portion covering the open portions, and the second cover portion may include a same material as the first cover portion.

The flow path may further include a fire extinguishing fluid injection port, and a total area of openings corresponding to battery cells farther from the fire extinguishing fluid injection port may be larger than a total area of openings corresponding to battery cells closer to the fire extinguishing fluid injection port, among the plurality of battery cells.

A melting point of the flow path may be equal to or higher than 800°.

Embodiments include a battery module, including a plurality of battery cells including a plurality of vents, respectively, the plurality of battery cells being in parallel to each other along a first direction, and a flow path on the plurality of battery cells, the flow path extending along the first direction and including a fire extinguishing fluid injection port, wherein the flow path includes a plurality of openings respectively corresponding to the plurality of vents of the plurality of battery cells, and a first cover portion covering each of the plurality of openings to define a first cover portion, and the plurality of openings include openings in an upper portion of the flow path and a lower portion of the flow path at positions corresponding to the plurality of vents, respectively.

The first cover portion encloses the flow path to cover each of the openings.

The battery module may further include an upper cover covering the plurality of battery cells, wherein the upper cover includes open portions respectively corresponding to the first cover portions.

The upper cover may further include a second cover portion covering the open portions, and the second cover portion includes a same material as the first cover portion.

At each position corresponding to the vents, a total area of the openings may increase in a direction away from the fire extinguishing fluid injection port.

At each position corresponding to the vents, a number of the openings may increase in a direction away from the fire extinguishing fluid injection port.

The first cover portion may further include a plug portion in each of the openings.

A melting point of the flow path may be higher than a melting point of the first cover.

A melting point of the flow path may be equal to or higher than 800°.

A material for the first cover may include at least one of polyamide, polycarbonate, polyether ether ketone, polyether ketone ketone, polyphenylene sulfide, polyether imide, polyether sulfone, and polyimide.

### BRIEF DESCRIPTION OF THE DRAWINGS

Features will become apparent to those of ordinary skill in the art by describing in detail exemplary embodiments with reference to the attached drawings, in which:

FIG. 1 is an exploded perspective view schematically illustrating an example of a battery module according to an embodiment of the disclosure;

FIG. 2 is a perspective view schematically illustrating an example of a battery cell of the battery module of FIG. 1;

FIG. 3 is a cross-sectional view schematically illustrating an example of the cross section E-E’ of FIG. 2;

FIG. 4 is a cross-sectional view schematically illustrating an example of a cross section of the battery module of FIG. 1;

FIG. 5 is a cross-sectional view schematically illustrating an example of the cross section A-A’ of FIG. 1;

FIG. 6 is a cross-sectional view schematically illustrating another example of the cross section A-A’ of FIG. 1;

FIG. 7 is a cross-sectional view schematically illustrating another example of the cross section A-A’ of FIG. 1;

FIG. 8 is an exploded perspective view schematically illustrating an example of a battery module according to another embodiment of the disclosure;

FIG. 9 is a cross-sectional view schematically illustrating another example of a cross section of the battery module of FIG. 1;

FIG. 10 is a cross-sectional view schematically illustrating an example of the cross section B-B’ of FIG. 9;

FIG. 11 is a cross-sectional view schematically illustrating an example of the cross section C-C’ of FIG. 9; and

FIG. 12 is a cross-sectional view schematically illustrating another example of the cross section C-C’ of FIG. 9.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In some embodiments, when used herein, the words “comprise”, “include”, and/or “comprising”, “including” specify the presence of stated features, numbers, steps, operations, members, elements and/or groups thereof, but do not exclude the presence or addition of one or more other features, numbers, operations, members, elements and/or groups thereof.

Although the terms first, second, or the like are used to describe various components, these components are not limited by these terms. These terms are only used to distinguish one component from another, and unless otherwise stated, it is of course the case that a first component may also be a second component.

Throughout the specification, unless otherwise specifically stated, each element may be singular or plural.

Any configuration being arranged “at top (or bottom) of” a component or “on (or below)” a component may mean not only that any configuration is arranged in contact with the upper surface (or lower surface) of the component, but also that other configurations may be interposed between the component and any configuration arranged on (or below) the component.

In some embodiments, when it is described that a component is “connected,” “coupled,” or “linked” to another component, it should be understood that the components may be directly connected or linked to each other, but that other components may also be “interposed” between the components, or that each component may be “connected,” “coupled,” or “linked” through other components. In some embodiments, when we say that a part is electrically coupled to another part, this includes not only cases where they are directly connected to each other, but also cases where they are connected to each other with another element in between.

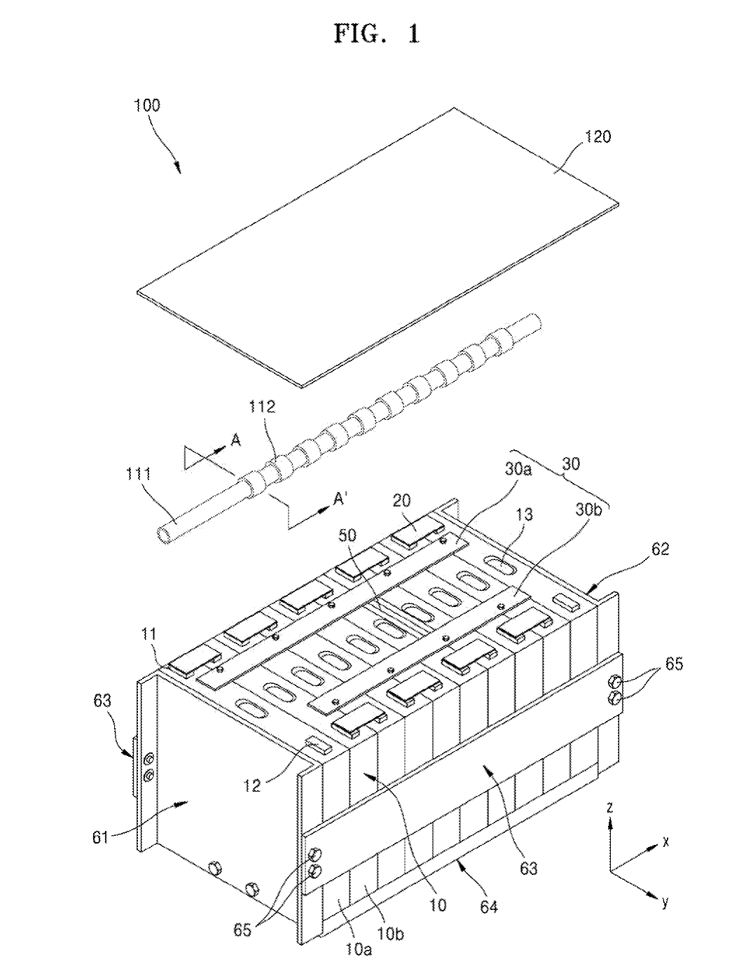

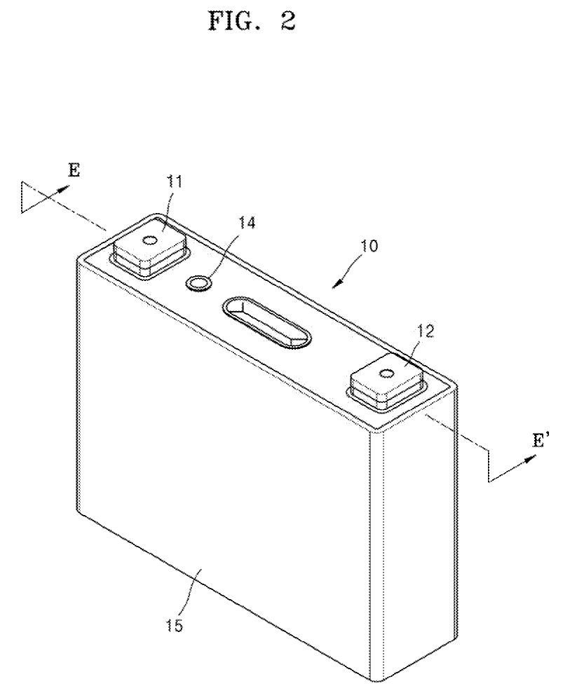

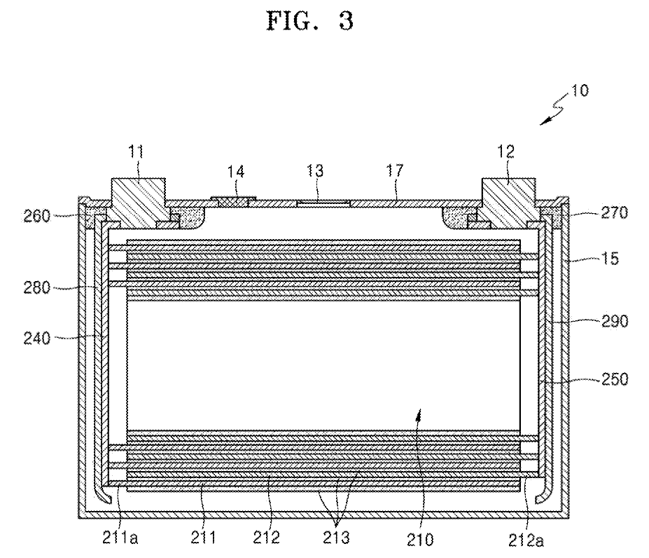

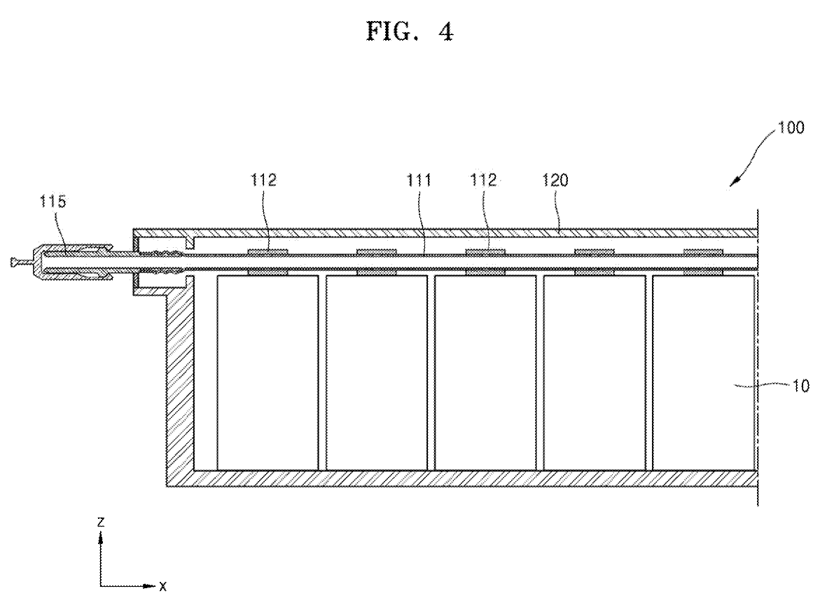

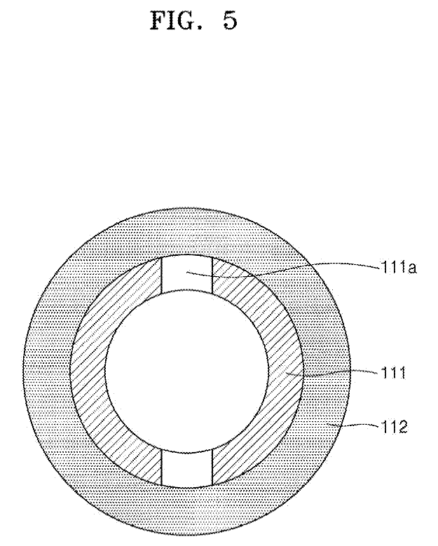

FIG. 1 is an exploded perspective view schematically illustrating an example of a battery module according to an embodiment of the disclosure, FIG. 2 is a perspective view schematically illustrating an example of a battery cell of the battery module of FIG. 1, FIG. 3 is a cross-sectional view schematically illustrating an example of a cross section taken along line E-E’ of FIG. 2, FIG. 4 is a cross-sectional view schematically illustrating an example of a cross section of the battery module of FIGS. 1 and 5, is a cross-sectional view schematically illustrating an example of a cross-section taken along line A-A’ of FIG. 1.

Referring to FIGS. 1-5, a battery module 100 according to an embodiment of the disclosure may be provided with terminal portions 11 and 12 including a first terminal 11 and a second terminal 12 and may include a plurality of battery cells 10 arranged in a direction x (e.g., the X-axis direction), a connection tab 20 connecting a battery cell 10a to another battery cell 10b adjacent thereto, and a protection circuit module 30 having an end portion at a side connected to the connection tab 20.

The protection circuit module 30 may be a battery management system (BMS). In some embodiments, the connection tab 20 may include a body portion which contacts the terminal portions 11 and 12 between the battery cells 10a and 10b, which are adjacent to each other, and an extension portion which extends from the body portion and is connected to the protection circuit module 30. The connection tab 20 may be a bus bar.

First, an individual of the plurality of battery cells 10 may include a battery case 15, an electrode assembly 210 accommodated within the battery case 15, and an electrolyte. The electrode assembly 210 and the electrolyte may react electrochemically to generate energy.

At a side of the battery cell 10, terminal portions 11 and 12 each electrically connected to a connection tab 20 and a vent 13 which is a passage for discharging gas generated internally may be provided. The terminal portions 11 and 12 of one of the plurality of battery cells 10 may be a first terminal 11 and a second terminal 12 including different polarities. In some embodiments, in case that (e.g., if) the first terminal 11 is a positive terminal, the second terminal 12 may be a negative terminal, and conversely, in case that the first terminal 11 is a negative terminal, the second terminal 12 may be a positive terminal. That is, the first terminal 11 and the second terminal 12 may include different electrical polarities.

The terminals 11 and 12 of the battery cells 10, which are adjacent to each other, may be electrically connected in series and/or in parallel by means of a connection tab 20. In some embodiments, a first terminal 11 of one of the plurality of battery cells 10 may be electrically connected to a second terminal 12 of another of the plurality of battery cells 10 adjacent thereto through a connection tab 20, and a second terminal 12 of the one of the plurality of battery cells 10 may be electrically connected to a first terminal 11 of yet another of the plurality of battery cells 10 adjacent thereto through another connection tab 20.

In some embodiments, although FIG. 1 may illustrate a serial connection as an example, various connection structures may be adopted as needed. In some embodiments, the number and arrangement of battery cells may vary from the structure illustrated in FIG. 1 and may be changed as needed.

A plurality of battery cells 10 may be arranged in a direction x so that the wide surfaces of the plurality of battery cells 10 face each other, and the plurality of battery cells 10, which are arranged, may be accommodated by housings 61, 62, 63, and 64.

The housings 61, 62, 63, and 64 may include a pair of end plates 61 and 62 each facing a wide surface of the plurality of battery cells 10 and side plates 63 and a bottom plate 64 each connecting the pair of end plates 61 and 62 to each other.

Each of the side plates 63 may support a side of a battery cell 10, and the bottom plate 64 may support a bottom surface of a battery cell 10. In some embodiments, the pair of end plates 61 and 62, each of the side plates 63, and the bottom plate 64 may be connected to each other by a member such as a bolt 65.

The protection circuit module 30 may mount electronic components, protection circuits, or the like, and may be electrically connected to a connection tab 20 to be described below.

The protection circuit module 30 may include a first protection circuit module 30a and a second protection circuit module 30b extending from different positions along a direction x (e.g., the X-axis direction) in which a plurality of battery cells 10 are arranged, and at this time, the first protection circuit module 30a and the second protection circuit module 30b may be spaced apart from each other by a certain distance but positioned parallel to each other so that each may be electrically connected to adjacent of the connection tabs 20.

In some embodiments, the first protection circuit module 30a may be formed to extend at a side of the upper portions of a plurality of battery cells 10 along a direction x in which the plurality of battery cells 10 are arranged, and the second protection circuit module 30b may be formed to extend at the other side of the upper portions of the plurality of battery cells 10 along a direction x in which the plurality of battery cells 10 are arranged, but the second protection circuit module 30b may be positioned to be spaced apart from the first protection circuit module 30a by a certain distance with a vent 13 in between, but may be arranged parallel to the first protection circuit module 30a.

In this way, the two protection circuit modules 30 may be arranged parallel to and spaced apart from each other along a direction x in which the plurality of battery cells are arranged, thereby minimizing the area of a printed circuit board (PCB) constituting a protection circuit module 30. A protection circuit module 30 may be configured separately as two protection circuit modules 30a and 30b to minimize the unnecessary area of PCM.

In some embodiments, the first protection circuit module 30a and the second protection circuit module 30b may be connected to each other by a connection member 50 that is conductive. At this time, a side of the connection member 50 may be connected to the first protection circuit module 30a, and the other side may be connected to the second protection circuit module 30b, so that electrical connection may be configured between the two protection circuit modules 30a and 30b.

The connection may be established by any one of soldering, resistance welding, laser welding or projection welding methods.

The connection member 50 may include a material having elasticity or flexibility. By means of such a connection member 50, the voltage, temperature, and current of a plurality of battery cells 10 may be checked and managed to ensure they are normal.

That is, information such as voltage, current, and temperature signals received by the first protection circuit module 30a from connection tabs 20 adjacent thereto and information such as voltage, current, and temperature received by the second protection circuit module 30b from connection tabs adjacent thereto may be integrated and managed by the protection circuit module 30 through the connection member.

In some embodiments, when a battery cell 10 swells, the shock may be absorbed by the elasticity or flexibility of the connection member 50, thereby preventing the first protection circuit module 30a and the second protection circuit module 30b from being damaged.

In some embodiments, the shape and structure of the connection member 50 may vary from the shape shown in FIG. 1.

In this way, because the protection circuit module 30 is provided with the first protection circuit module 30a and the second protection circuit module 30b, the area of PCB constituting the protection circuit module 30 may be minimized, thereby securing space inside the battery module 100. This may improve work efficiency by facilitating repairs when an abnormality is detected in the battery module 100 as well as the fastening work of connecting a connection tab 20 and the protection circuit module 30 to each other.

In some embodiments, a battery cell 10 according to an embodiment of the disclosure may include at least one of an electrode assembly 210 in which a first electrode plate 211 and a second electrode plate 212 including a plurality of sheets are alternately laminated with each other with a separator 213 in between, and a battery case 15 in which the electrode assembly 210 is accommodated.

The first electrode plate 211 and the second electrode plate 212 of a battery cell 10 may have different polarities. In some embodiments, in case that the first electrode plate 211 is a positive electrode, the second electrode plate 212 may be a negative electrode, and conversely, in case that the first electrode plate 211 is a negative electrode, the second electrode plate 212 may be a positive electrode. That is, the first electrode plate 211 and the second electrode plate 212 may include different electrical polarities.

A battery cell 10 according to an embodiment may be described as including a square shape as an example. However, the disclosure may be applied to various types of battery cells such as pouch cells or cylindrical battery cells.

The first electrode plate 211 and the second electrode plate 212 each may include a coated portion, which is an area where an active material is applied to a current collector including a metal foil of a thin plate, and a first uncoated portion 211a and a second uncoated portion 212a, each of which is an area where the active material is not applied.

The electrode assembly 210 may include a structure in which a first electrode plate 211 and a second electrode plate 212 including a plurality of sheets are alternately laminated with each other with a separator 213 in between. However, the first electrode plate 211 and the second electrode plate 212 may be wound after being interposed a separator 213, which is an insulator, therebetween.

The battery case 15 may form the overall appearance of a battery cell 10 and may include a conductive metal such as aluminum, an aluminum alloy, or nickel-plated steel. In some embodiments, the battery case 15 may provide a space in which the electrode assembly 210 is accommodated.

A battery cell 10 may include a cap plate 17 covering an opening of the battery case 15, and the battery case 15 and the cap plate 17 each may include a conductive material. In this regard, the first terminal 11 and the second terminal 12 electrically connected to the first electrode plate 211 or the second electrode plate 212 may be installed to protrude outward by penetrating the cap plate 17.

In some embodiments, the outer main surfaces of upper pillars of the first terminal 11 and the second terminal 12 protruding outward from the cap plate 17 may be threaded and each may be fixed to the cap plate 17 with a nut.

However, the first terminal 11 and the second terminal 12 each including a riveted-structure may be riveted or may be welded to the cap plate 17.

In some embodiments, the cap plate 17 including a thin plate may be coupled to the opening of the battery case 15, and an electrolyte injection port 14 into which a sealing plug may be installed may be formed in the cap plate 17, and a vent 13 having a notch may be installed.

The first terminal 11 and the second terminal 12 may be electrically connected to a current collector including a first current collector 240 and a second current collector 250 which are welded to a first uncoated portion 211a of the first electrode plate and a second uncoated portion 212a of the second electrode plate, respectively.

In some embodiments, the first terminal 11 and the second terminal 12 may be welded to the first current collector 240 and the second current collector 250, respectively. However, the first terminal 11 and the second terminal 12 and the first current collector 240 and the second current collector 250 may be formed by being integrally coupled to each other (e.g., a monolithic structure of the first terminal 11 and the first current collector 240).

In some embodiments, an insulation member may be installed between the electrode assembly 210 and the cap plate 17. In this regard, the insulation member may include a first lower insulation member 260 and a second lower insulation member 270, and each of the first lower insulation member 260 and the second lower insulation member 270 may be installed between the electrode assembly 210 and the cap plate 17.

In some embodiments, according to the disclosure, an end of a separation member which may be installed facing a side surface of the electrode assembly 210 may be installed between an insulation member and each of the first terminal 11 and the second terminal 12. In this regard, the separation member may include a first separation member 280 and a second separation member 290.

Accordingly, an end of the first separation member 280 and an end of the second separation member 290 which may be installed facing a side of the electrode assembly 210 may be installed between the first lower insulation member 260 and the second lower insulation member 270 and the first terminal 11 and the second terminal 12, respectively.

Finally, the first terminal 11 and the second terminal 12 welded to the first current collector 240 and the second current collector 250 may be coupled to the first lower insulation member 260 and the second lower insulation member 270 and an end of the first separation member 280 and an end of the second separation member 290.

In some embodiments, the battery module 100 may further include a plurality of battery cells 10, each including a vent 13, arranged in parallel along a first direction x (e.g., the X-axis direction), an upper cover 120 covering the plurality of battery cells 10, and a flow path 111 positioned between the plurality of battery cells 10 and the upper cover 120 and through which fire extinguishing fluid flows and extending in the first direction x.

For example, referring to FIG. 1, the flow path 111 may be a tube extending along the plurality of battery cells 100, and may include a plurality of openings 111a each corresponding to (e.g., vertically overlapping) a respective vent 13 of the plurality of battery cells 10. The flow path 111 may further include a first cover portion 112 covering each of the plurality of openings 111a (see FIG. 5), fire extinguishing fluid flowing inside the flow path 111, and a fire extinguishing fluid injection port 115 (see FIG. 4) into which the fire extinguishing fluid is injected. In some embodiments, a plurality of openings 111a may include openings positioned in both an upper portion of the flow path 111 and a lower portion of the flow path 111 at a position of a corresponding one (e.g., an aligned one) of a plurality of vents 13.

The first cover portion 112 may enclose the flow path 111 to cover an opening 111a at a position where the opening 111a is formed. That is, in an area where the first cover portion 112 encloses the flow path 111, the flow path 111 may include an opening 111a, and in an area where the first cover portion 112 does not enclose the flow path 111, the flow path 111 may not include an opening 111a.

As a result, the first cover portion 112 may enclose the flow path 111 to cover an opening 111a of the flow path 111, and in an area where the first cover portion 112 does not enclose the flow path, the flow path 111 does not include an opening 111a, thereby preventing leakage of the fire extinguishing fluid flowing inside the flow path 111.

In some embodiments, the melting point of the flow path 111 may be higher than the temperature at the time of thermal runaway occurring in the battery module 100. In some embodiments, the melting point of the flow path 111 may be equal to or greater than 800° (e.g., degrees Celcius). Accordingly, the flow path 111 may include a material having a high melting point. In some embodiments, the material of the flow path 111 may include at least one of alumina (Al₂O₃), zirconia (ZrO₂), silicon carbide, graphite, tungsten, or molybdenum, but this may vary, and any material may be used as long as the melting point of the flow path 111 is higher than the temperature at the time of thermal runaway occurring in the battery module 100, so that the flow path 111 does not melt even at the time of thermal runaway of the battery module 100.

In this way, in case that the flow path 111 does not melt even when thermal runaway of the battery module 100 occurs, the flow path 111 may be reused later even after the fire extinguishing fluid sprayed from the flow path 111 suppresses the thermal runaway of the battery module 100, thereby reducing the manufacturing cost of the battery module 100.

In some embodiments, the melting point of the first cover portion 112 may be lower than the melting point of the flow path 111. In some embodiments, the first cover portion 112 may melt in the event of thermal runaway of a battery cell 10. The material for the first cover portion 112 may include at least one of polyamide (PA), polycarbonate (PC), polyether ether ketone (PEEK), polyether ketone ketone (PEKK), polyphenylene sulfide (PPS), polyether imide (PEI), polyether sulfone (PES), or polyimide (PI), but this may vary.

In this way, in case that the first cover portion 112 melts during thermal runaway of a battery cell 10, the openings 111a positioned at the bottom of the flow path 111 enclosed by the first cover portion 112 may be exposed so that the fire extinguishing fluid stored inside the flow path 111 may be sprayed toward the battery cell 10 to suppress the thermal runaway.

In some embodiments, fire may occur not only inside the battery module 100, but also outside the upper cover 120 of the battery module 100. In a case where the flow path 111 includes an opening 111a positioned in the upper portion of the flow path 111, the upper cover 120 and the first cover portion 112 may be melted by heat, thereby allowing the fire extinguishing fluid to be sprayed toward the upper portion the flow path 111. As a result, the safety of the battery module 100 may be improved by extinguishing the fire which occurred outside the battery module 100 just like the thermal runaway which occurred in the battery cell 10.

The flow path 111 may be configured to spray the fire extinguishing fluid stored therein toward the battery cells 10 and the upper cover 120 when a temperature equal to or more than a predetermined level is reached. In some embodiments, the fire extinguishing fluid flowing inside the flow path 111 may include halogenated carbon which absorbs heat through latent heat of vaporization to cool a battery cell 10. In some embodiments, the fire extinguishing fluid may include a smothering extinguishing material which extinguishes fire by blocking oxygen, such as a solid aerosol, but this may vary.

In some embodiments, each of the housings 61, 62, 63, and 64 may be coupled to the upper cover 120 using a fastening member such as a bolt, but any method that can be used for fastening may be possible. The upper cover 120 may be coupled to the housings 61, 62, 63, and 64 to form an internal space, and a plurality of battery cells 10 and a flow path 111 may be accommodated in the internal space. Accordingly, the material of each of the upper cover 120 and the housings 61, 62, 63, and 64 may need to be a material which may protect the plurality of battery cells 10 and the flow path 111 from mechanical impact or the like.

Accordingly, the material of each of the upper cover 120 and the housings 61, 62, 63, and 64 may include a durable material, such as at least one of acrylonitrile butadiene styrene (ABS), polycarbonate (PC), polypropylene (PP), aluminum, or stainless steel, but this may vary.

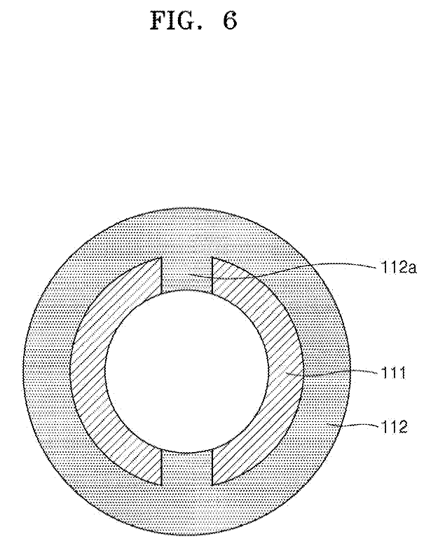

FIG. 6 is a cross-sectional view schematically illustrating another example of a cross section taken along line A-A’ of FIG. 1.

Referring to FIG. 6, a first cover portion 112 according to another embodiment of the disclosure may include a plug portion 112a introduced into an opening 111a of the flow path 111. The plug portion 112a may include the same material as the first cover portion 112.

In case that the first cover portion 112 includes a plug portion 112a introduced into an opening 111a of the flow path 111, the fire extinguishing fluid flowing inside the flow path 111 does not accumulate in the openings 111a, so the fluidity of the fire extinguishing fluid flowing inside the flow path 111 may increase. As a result, the safety of the battery module 100 may be improved by quickly extinguishing the fire occurring in the battery module 100.

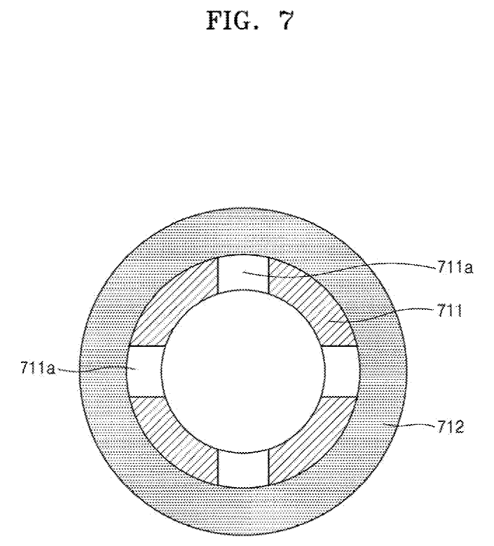

FIG. 7 is a cross-sectional view schematically illustrating another example of the cross section taken along line A-A’ of FIG. 1.

Referring to FIG. 7, at least three of a plurality of openings 711a formed in a flow path 711 according to another embodiment of the disclosure may be arranged along an outer circumferential surface of the flow path 711 in a cross section of the flow path perpendicular to a longitudinal direction x of the flow path. In some embodiments, a plurality of openings 711a may be formed in the top, bottom, and both sides of the flow path 711. Each of the four openings 711a may be covered by a first cover portion 712 enclosing the flow path 711.

In case that fire occurs at the outside of the upper cover of the battery module, the upper cover and the first cover portion 712 may melt. As a result, the fire extinguishing fluid flowing inside the flow path 711 may be sprayed to the upper portion of the battery module to extinguish the fire.

In case that thermal runaway occurs in a particular battery cell, hot gases and flames may be released from a vent. As a result, the first cover portion 712 positioned in the area overlapping with the vent may be melted, and the fire extinguishing fluid flowing inside the flow path 711 may be sprayed toward the battery cell from the opening 711a positioned in the bottom of the flow path 711, thereby extinguishing the fire.

In some embodiments, as described above, high-temperature gases and flames may be released from a vent, but in the event of thermal runaway of a battery cell, a first terminal or a second terminal may short-circuit by contacting debris released from a battery cell in which thermal runaway has occurred, causing additional fire. In such a case, as illustrated in FIG. 7, the fire may be extinguished by spraying fire extinguishing fluid toward the first terminal or second terminal of a battery cell from the openings positioned on the opposite sides of the flow path 711, thereby improving the stability of the battery module.

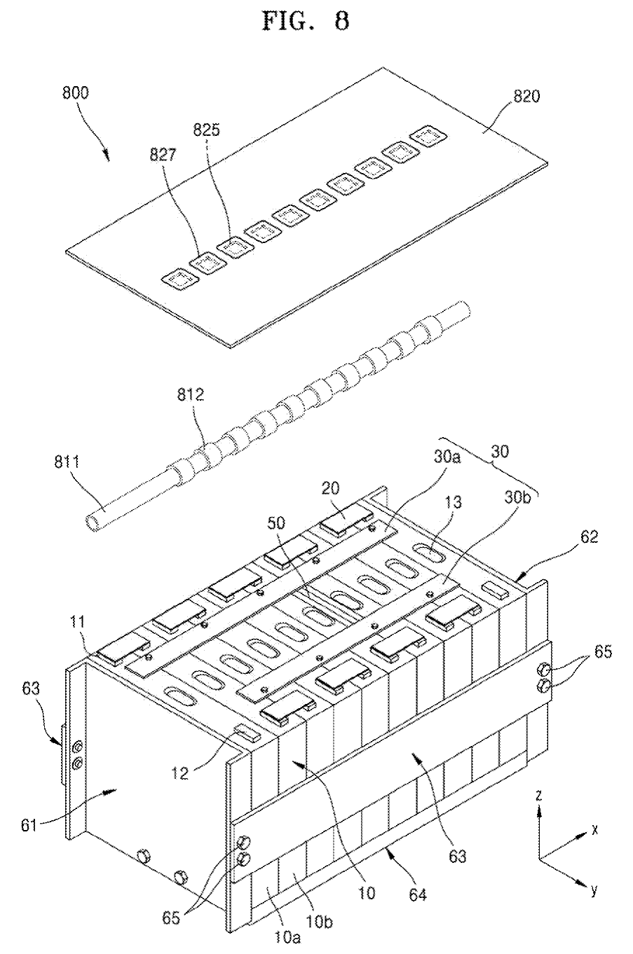

FIG. 8 is an exploded perspective view schematically illustrating an example of a battery module according to another embodiment of the disclosure.

Referring to FIG. 8, a battery module 800 according to another embodiment of the disclosure may include a plurality of battery cells 10, each including a vent 13, arranged in parallel along a first direction x (e.g., the X-axis direction), an upper cover 820 covering the plurality of battery cells 10, and a flow path 811 positioned between the plurality of battery cells 10 and the upper cover 820 and through which fire extinguishing fluid flows.

The flow path 811 may include a plurality of openings respectively corresponding to the vents 13 of the plurality of battery cells 10, a first cover portion 812 covering each of the plurality of openings, fire extinguishing fluid flowing inside the flow path 811, and a fire extinguishing fluid injection port into which the fire extinguishing fluid is injected. In some embodiments, a plurality of openings may include openings positioned in both an upper portion of the flow path 811 and a lower portion of the flow path 811 at a position of a corresponding one of a plurality of vents 13.

The upper cover 820 may include open portions 825 respectively corresponding to the first cover portions 812. In case that the upper cover 820 includes open portions 825, there may be a risk that the interior of the battery module 800 may be exposed. Accordingly, the upper cover 820 may further include second cover portions 827 covering the open portions 825, and the second cover portions 827 may include the same material as the first cover portions 812.

In some embodiments, a second cover portion 827 may be in the form of a film such as a tape, but the shape of a second cover portion 827 may be any shape as long as it may cover an open portion 825. In some embodiments, a second cover portion 827 may include a plug introduced into an open portion 825.

As described above, fire may occur at the outside of the upper cover 820 of the battery module 800. In this case, because the upper cover 820 includes a second cover portion 827 which may melt when fire occurs, the upper cover 820 may melt quickly. In some embodiments, a first cover portion 812 of the flow path 811 positioned within the upper cover 820 may also be melted by flames. As a result, fire extinguishing fluid flowing through the flow path 811 may be quickly sprayed to the outside of the upper cover 820, where the fire has occurred, to extinguish the fire, thereby improving the stability of the battery module 800.

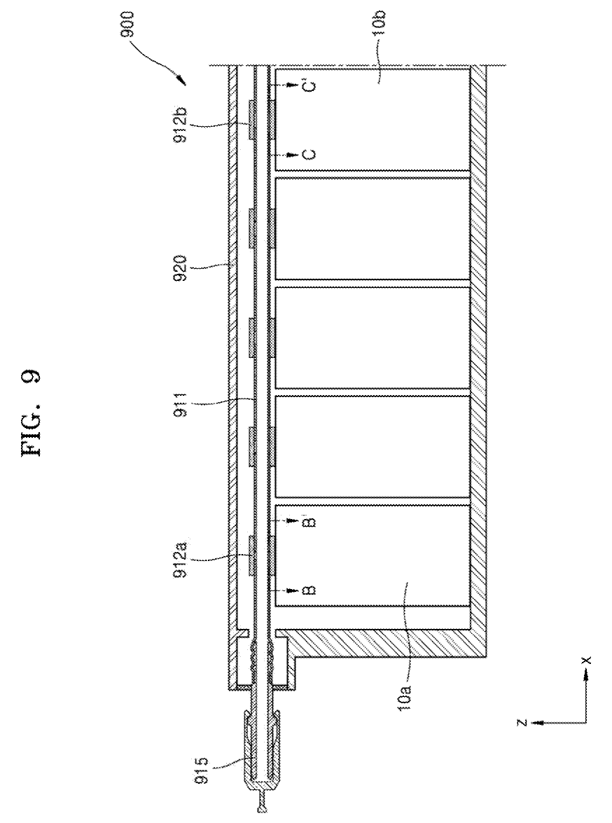

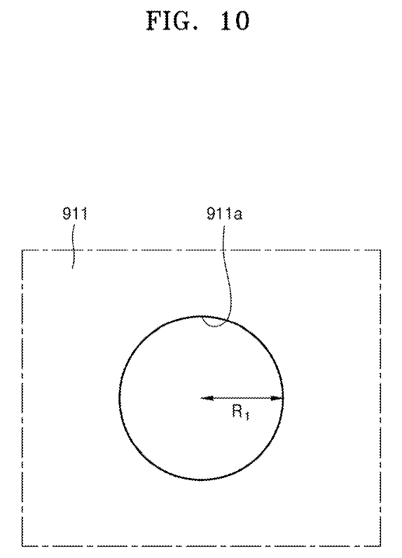

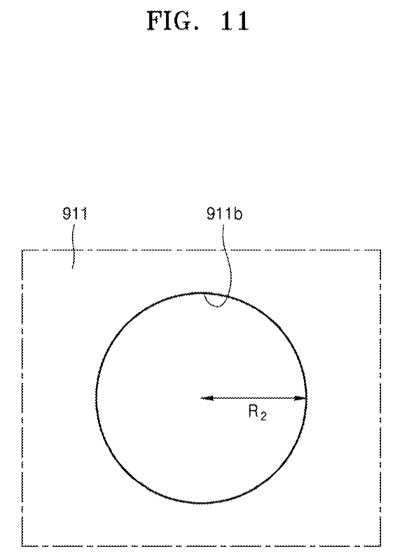

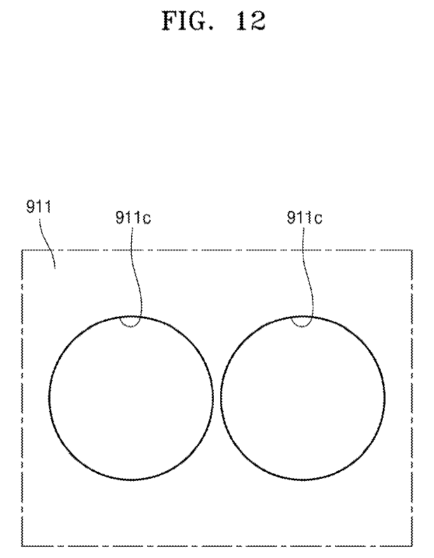

FIG. 9 is a cross-sectional view schematically illustrating another example of a cross section of the battery module of FIG. 1, FIG. 10 is a cross-sectional view schematically illustrating an example of a cross section taken along line B-B’ of FIG. 9, FIG. 11, is a cross-sectional view schematically illustrating an example of the cross section taken along line C-C’ of FIGS. 9 and 12, is a cross-sectional view schematically illustrating another example of the cross section taken along line C-C’ of FIG. 9.

Referring to FIGS. 9-12 together with FIG. 1, a battery module 900 according to another embodiment of the disclosure may include a plurality of battery cells 10, each including a vent 13, arranged in parallel along a first direction x (e.g., the X-axis direction), an upper cover 920 covering the plurality of battery cells 10, and a flow path 911 positioned between the plurality of battery cells 10 and the upper cover 920 and through which fire extinguishing fluid flows.

The flow path 911 may include a plurality of openings 911a and 911b, each corresponding to one of the vents 13 of a plurality of battery cells 10, first cover portions 912a and 912b respectively covering the plurality of openings 911a and 911b, fire extinguishing fluid flowing inside the flow path 911, and a fire extinguishing fluid injection port 915 into which the fire extinguishing fluid is injected. In some embodiments, a plurality of openings 911a and 911b may include openings positioned in both an upper portion of the flow path 911 and a lower portion of the flow path 911 at positions corresponding to respective ones of a plurality of vents 13.

The total area of the openings 911a and 911b may increase as farther away (e.g., in a direction away) from the fire extinguishing fluid injection port 915. That is, the total area of the openings 911b corresponding to a battery cell 10b which is farther from the fire extinguishing fluid injection port 915 may be larger than the total area of the openings 911a corresponding to a battery cell 10a which is closer to the fire extinguishing fluid injection port 915 among the battery cells 10. In some embodiments, the radius R2 of an opening 911b arranged relatively far from the fire extinguishing fluid injection port 915 may be larger than the radius R1 of an opening 911a arranged close to the fire extinguishing fluid injection port 915.

In some embodiments, thermal runaway may occur simultaneously in the battery cells 10. In some embodiments, in case that thermal runaway occurs in a battery cell 10a positioned under a first cover portion 912a arranged close to the fire extinguishing fluid injection port 915 and a battery cell 10b positioned under a first cover portion 912b arranged relatively far from the fire extinguishing fluid injection port 915, the pressure of the fire extinguishing fluid flowing through the flow path 911 may decrease as it moves away from the fire extinguishing fluid injection port 915. As a result, there is a concern that thermal runaway occurring in the battery cell 10b relatively far from the fire extinguishing fluid injection port 915 may not be effectively suppressed.

However, as in the battery module 900 according to another embodiment of the disclosure, in the case where the total area of openings 911a and 911b increases as farther away (e.g., in a direction away) from the fire extinguishing fluid injection port 915, the flow rate of the fire extinguishing fluid passing through the opening 911b may increase due to the increase in the area of the opening 911b, despite the pressure of the fire extinguishing fluid decreasing as it gets farther away from the fire extinguishing fluid injection port 915. Accordingly, by spraying the fire extinguishing fluid to the battery cells 10a and 10b where thermal runaway has occurred in the flow path 911, the thermal runaway may be suppressed, thereby improving the stability of the battery module 900.

As another way to compensate for the pressure of the fire extinguishing fluid decreasing as it gets farther away from the fire extinguishing fluid injection port 915, as shown in FIG. 12, the number of openings 911c may increase as they get farther away from the fire extinguishing fluid injection port 915. That is, the number of openings 911c in an area relatively far from the fire extinguishing fluid injection port 915 may be greater than the number of openings 911c in an area adjacent to the fire extinguishing fluid injection port 915.

In some embodiments, in an area adjacent to the fire extinguishing fluid injection port 915, the flow path 911 may include an opening 911c corresponding to a vent 13 of a battery cell 10, and in an area relatively distant from the fire extinguishing fluid injection port 915, the flow path 911 may include two of the opening 911c. However, in case that the number of openings 911c in an area relatively distant from the fire extinguishing fluid injection port 915 is greater than the number of openings 911c in an area adjacent to the fire extinguishing fluid injection port 915, the flow path 911 may include a variable number of openings 911c.

In case that the number of openings 911c increases as farther away from the fire extinguishing fluid injection port 915, the total flow rate of the fire extinguishing fluid sprayed through the openings 911c increases, just as the area of the openings 911c increases, so that when thermal runaway occurs in the battery cell 10b, the thermal runaway may be efficiently suppressed, thereby improving the stability of the battery module 900.

According to embodiments of the disclosure, the battery module may include a flow path through which fire extinguishing fluid flows and a first cover portion which encloses a portion of the flow path and has a melting point lower than that of the flow path, so that when thermal runaway of the battery module occurs, the fire extinguishing fluid may be sprayed from the flow path to extinguish the battery module, thereby improving the stability of the battery module.

In some embodiments, the flow path may reduce the manufacturing cost of the battery module by reusing the flow path even after the thermal runaway of the battery module has been extinguished.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of skill in the art that various changes in form and details may be made without departing from the spirit and scope of the present invention as set forth in the following claims.

What is claimed is:

1. A battery module, comprising:
a plurality of battery cells including a plurality of vents, respectively, the plurality of battery cells being in parallel to each other along a first direction;
an upper cover covering the plurality of battery cells; and
a flow path positioned between the plurality of battery cells and the upper cover, a fire extinguishing fluid flowing in the flow path,
wherein the flow path includes a plurality of openings respectively corresponding to the plurality of vents of the plurality of battery cells and a first cover portion covering each of the plurality of openings to define a first cover portion.

2. The battery module as claimed in claim 1, wherein the plurality of openings include openings in an upper portion of the flow path and a lower portion of the flow path at positions corresponding to the plurality of vents, respectively.

3. The battery module as claimed in claim 1, wherein the first cover portion encloses the flow path to cover each of the plurality of openings.

4. The battery module as claimed in claim 1, wherein the first cover portion further includes a plug portion in each of the plurality of openings.

5. The battery module as claimed in claim 1, wherein a melting point of the flow path is higher than a melting point of the first cover portion.

6. The battery module as claimed in claim 1, wherein at least three of the plurality of openings are along an outer circumferential surface of the flow path in a cross section of the flow path which is perpendicular to a longitudinal direction of the flow path.

7. The battery module as claimed in claim 1, wherein the upper cover includes open portions respectively corresponding to the first cover portion of each of the plurality of openings.

8. The battery module as claimed in claim 7, wherein:
the upper cover further includes a second cover portion covering the open portions, and
the second cover portion includes a same material as the first cover portion.

9. The battery module as claimed in claim 1, wherein:
the flow path further includes a fire extinguishing fluid injection port, and
a total area of openings corresponding to the plurality of battery cells farther from the fire extinguishing fluid injection port is larger than a total area of openings corresponding to the plurality of battery cells closer to the fire extinguishing fluid injection port, among the plurality of battery cells.

10. The battery module as claimed in claim 1, wherein a melting point of the flow path is equal to or higher than 800°.

11. A battery module, comprising:
a plurality of battery cells including a plurality of vents, respectively, the plurality of battery cells being in parallel to each other along a first direction; and
a flow path on the plurality of battery cells, the flow path extending along the first direction and including a fire extinguishing fluid injection port, wherein:
the flow path includes a plurality of openings respectively corresponding to the plurality of vents of the plurality of battery cells, and a first cover portion covering each of the plurality of openings to define a first cover portion, and
the plurality of openings include openings in an upper portion of the flow path and a lower portion of the flow path at positions corresponding to the plurality of vents, respectively.

12. The battery module as claimed in claim 11, wherein the first cover portion encloses the flow path to cover each of the openings.

13. The battery module as claimed in claim 11, further comprising:
an upper cover covering the plurality of battery cells,
wherein the upper cover includes open portions respectively corresponding to the first cover portion.

14. The battery module as claimed in claim 13, wherein:
the upper cover further includes a second cover portion covering the open portions, and
the second cover portion includes a same material as the first cover portion.

15. The battery module as claimed in claim 11, wherein at each position corresponding to the vents, a total area of the openings increases in a direction away from the fire extinguishing fluid injection port.

16. The battery module as claimed in claim 11, wherein at each position corresponding to the vents, a number of the openings increases in a direction away from the fire extinguishing fluid injection port.

17. The battery module as claimed in claim 11, wherein the first cover portion further includes a plug portion in each of the openings.

18. The battery module as claimed in claim 11, wherein a melting point of the flow path is higher than a melting point of the first cover portion.

19. The battery module as claimed in claim 11, wherein a melting point of the flow path is equal to or higher than 800°.

20. The battery module as claimed in claim 11, wherein a material for the first cover portion includes at least one of polyamide, polycarbonate, polyether ether ketone, polyether ketone ketone, polyphenylene sulfide, polyether imide, polyether sulfone, and polyimide.
